(19) United States
(12) Patent Application Publication
(10) Pub. No.: US 2015/0235187 A1
(43) Pub. Date: Aug. 20, 2015

(54) Real-Time Data Capture and Distribution System for E-Commerce Payment Transactions

(71) Applicant: Newtek Business Services, Inc., New York, NY (US)

(72) Inventors: Craig J. Brunet, Scottsdale, AZ (US); Robert P. Cichon, Phoenix, AZ (US); Lance P. Hupper, Glendale, AZ (US)

(21) Appl. No.: 14/429,312

(22) PCT Filed: Sep. 18, 2013
(86) PCT No.: PCT/US2013/060422

§ 371 Date: Mar. 18, 2015

Related U.S. Application Data
(60) Provisional application No. 61/799,301, filed on Mar. 15, 2013.
(60) Provisional application No. 61/702,440, filed on Sep. 18, 2012.

(51) Int. Cl. G06Q 20/02; G06Q 20/40

(52) U.S. Cl. CPC G06Q 20/027; G06Q 20/40

(57) ABSTRACT

Real-time data capture and distribution for e-commerce payment transactions which includes receiving, at a secure gateway, a payment transaction request sent from a virtual terminal of a customer website via a network. The payment transaction request includes a merchant identifier associated with the virtual terminal. The payment transaction data is stored in a database accessible by the secure gateway. The payment transaction data is sent from the secure gateway to be stored by a merchant data capture service in association with the merchant identifier. A customer data portal executing on a customer device retrieves the payment transaction data from the merchant data capture service based on the merchant identifier. The payment transaction data is presented on the customer device by the customer data portal.

### CROSS-REFERENCE TO RELATED APPLICATIONS

This is a U.S. national stage of application No. PCT/US2013/060422, filed on 18 Sep. 2013, which claims the benefit of U.S. Provisional Patent Application No. 61/702,440, filed Sep. 18, 2012 and U.S. Provisional Patent Application No. 61/799,301, filed Mar. 15, 2013, both of which are hereby incorporated by reference in their entireties.

### FIELD OF THE INVENTION

The disclosed embodiments relate to real-time data capture and distribution system for e-commerce payment transactions.

### BACKGROUND OF THE INVENTION

E-commerce, which is now ubiquitous, typically involves goods and services made available on a publicly-accessible Internet website. The desired merchandise is selected by a consumer by navigating the website and added to a “shopping cart” to be purchased. The shopping cart is associated with a particular merchant electronic payment processing account. Thus, e-commerce includes the merchant website (in the examples discussed herein, the merchant website is referred to as the “customer website” because the merchant is the customer of a provider of e-commerce facilities and/or services) with the goods and services on it to be sold and an electronic payment account to allow the goods to be purchased using a form of electronic payment, such as VISA, MasterCard, American Express, or Discover.

Tracking website activity and sales is of vital importance to e-commerce merchants. Merchants are generally interested in two different types of information. One of these types of information involves the customer activity associated with the website itself. In other words, how many people are accessing the website and how frequently. The other type of information, which typically comes from an entirely separate source, is how much dollar activity is occurring in the merchant's payment account due to sales on the website.

However, in conventional e-commerce systems, there is no way to deliver to a merchant in real time, e.g., in a visual format, a presentation of both: (a) the statistical activity, e.g., traffic in terms of visits, on the merchant's website; and (b) the real-time dollar value of sales transactions and the number of transactions. Conventionally, these two distinct types of merchant information are transmitted via different infrastructures from different sources.

In conventional e-commerce systems, electronic payment transactions typically pass through a computer-implemented payment processing system referred to as a “gateway.” In conventional gateways, there is no way to extract, in real time, a merchant identification (ID) number and any activity associated with that merchant ID and direct this activity into a separate database for presentation to a merchant. As a result, there is no practical way to provide a merchant with real-time information regarding customer purchases using the e-commerce website.

For example, a customer may have a favorite steakhouse which sells its sauces on an e-commerce website. To purchase these sauces, the customer will go to the website, add the desired items to a shopping cart, and initiate the “checkout” process. In the checkout process, the user is presented with access to the payments side of the website. After the customer decides how they wish to pay for the items, the customer enters payment information, such as credit card information, and clicks on a button to submit the transaction. The payment information passes through the merchant's chosen gateway into the electronic payments network to an electronic payments processor, which could be a credit card processor, such as First Data Corporation. The credit card processor then authorizes the transaction, assuming the credit card information entered by the customer was valid. However, the merchant will not have access to information relating to this payment transaction typically for at least 24 hours. Furthermore, to access website traffic information, the merchant would have to log on separately to a website statistics account.

Therefore, it can be seen that conventional e-commerce systems do not provide a merchant with real-time information regarding both website traffic and payment transactions.

### SUMMARY OF THE INVENTION

The disclosed embodiments provide a real-time data capture and distribution system for e-commerce payment transactions and website activity statistics. The combination of data relating to both e-commerce payment transactions and website activity statistics helps an e-commerce merchant to make informed decisions regarding marketing and promotional activities.

As an example of how data relating to both e-commerce payment transactions and website activity statistics may be used in practice, suppose a merchant runs a four-day advertising campaign in a local area in an attempt to drive consumer traffic to their e-commerce website. With the disclosed system, the merchant could be at lunch with his mobile device, e.g., iPad, iPhone, Android device, Galaxy tablet, etc., and have real-time charts delivered directly to the mobile device which would show what kind of return the merchant is receiving on the money spent for the advertising at that very moment. This data answers the two very important questions for the merchant: am I seeing traffic and is it driving sales?

Thus, the disclosed embodiments involve the capture, e.g., from a gateway, of real-time financial transaction data from an e-commerce site, combined with the traffic statistics from that site, e.g., how many unique visitors, how many site visits, and how many unique site visits. This, in a sense, allows the e-commerce merchant to be like a “Home Shopping Network” in the cloud, because the merchant can actually see in real-time what is going on with their website from both a traffic and financial perspective.

Embodiments of the present invention disclosed herein include systems, methods, and computer programs for performing real-time data capture and distribution for e-commerce payment transactions. In particular, disclosed embodiments include receiving, at a secure gateway comprising data storage and a network interface, a payment transaction request sent from a virtual terminal of a customer website via a network. The payment transaction request includes a merchant identifier associated with the virtual terminal. Payment transaction data is stored in a database accessible by the secure gateway, the payment transaction data being based on the transaction request. The payment transaction data is sent from the secure gateway, via the network, to be stored by a merchant data capture service in association with the merchant identifier, the merchant data capture service including data storage and a network interface. A customer data portal at least partially executing on a processor of a customer device retrieves the payment transaction data from the merchant data capture service based on the merchant identifier. The customer data portal also presents the payment transaction data on the customer device.

Embodiments of the present invention may also include one or more of the following features.

The merchant data capture service may website activity statistics from the customer website in association with the merchant identifier. The customer data portal may retrieve website activity statistics for the customer website from a web statistics collector based on the merchant identifier. The customer data portal may present the website activity statistics on the customer device. The customer data portal may simultaneously present portions of the payment transaction data and corresponding portions of the website activity statistics on the customer device.

Payment information based on the transaction request may be sent via the network to a payment processor for authorization. The secure gateway may receive a payment authorization response from the payment processor via the network in response to the payment information. The sending of the payment information to the payment processor and the receiving of the payment authorization response may be performed by a payment transaction switch associated with the secure gateway.

The payment transaction data may be sent from the secure gateway to be stored by the merchant data capture service through a data push operation. The retrieving of the payment transaction data by the customer data portal may include retrieval of historical payment transaction data stored by the merchant data capture service.

The payment transaction request may include a personal account identifier. The personal account identifier may be processed to form a protected account identifier, and the protected account identifier may be stored as part of the payment transaction data.

### BRIEF DESCRIPTION OF THE DRAWINGS

The above and/or other aspects and advantages will become more apparent and more readily appreciated from the following detailed description of the disclosed embodiments taken in conjunction with the accompanying drawings of which:

FIG. 1 is a block diagram showing the components of a real-time data capture and distribution system for e-commerce payment transactions and website activity statistics; and

FIG. 2 depicts an example of a data screen presented on an electronic device of a user showing charts of e-commerce payment transactions and website activity statistics.

FIG. 3 is a block diagram of the merchant gateway subsystem (i.e., “secure gateway”).

FIG. 4 is a block diagram of the merchant data collection subsystem.

FIG. 5 is an alternative block diagram of the real-time data capture and distribution system.

FIG. 6 depicts an example of a data screen presented on an electronic device of a user showing cumulative merchant payment transaction statistics for specific periods of time.

FIG. 7 depicts an example of a data screen presented on an electronic device of a user showing an aggregated view of merchant e-commerce website statistics and payment transaction statistics.

FIG. 8 depicts an example of a data screen presented on an electronic device of a user showing a rate merchant payment transactions over a specific period of time.

FIG. 9 depicts an example of a data screen presented on an electronic device of a user showing total merchant sales over a specific period of time.

FIG. 10 depicts an example of a data screen presented on an electronic device of a user showing payment transactions declined over a specific period of time.

FIG. 11 depicts an example of a data screen presented on an electronic device of a user showing an inbox of received messages relating to merchant payment transactions and administrative information.

FIG. 12 depicts an example of a data screen presented on an electronic device of a user showing a received message relating to merchant payment transaction chargebacks.

### DETAILED DESCRIPTION

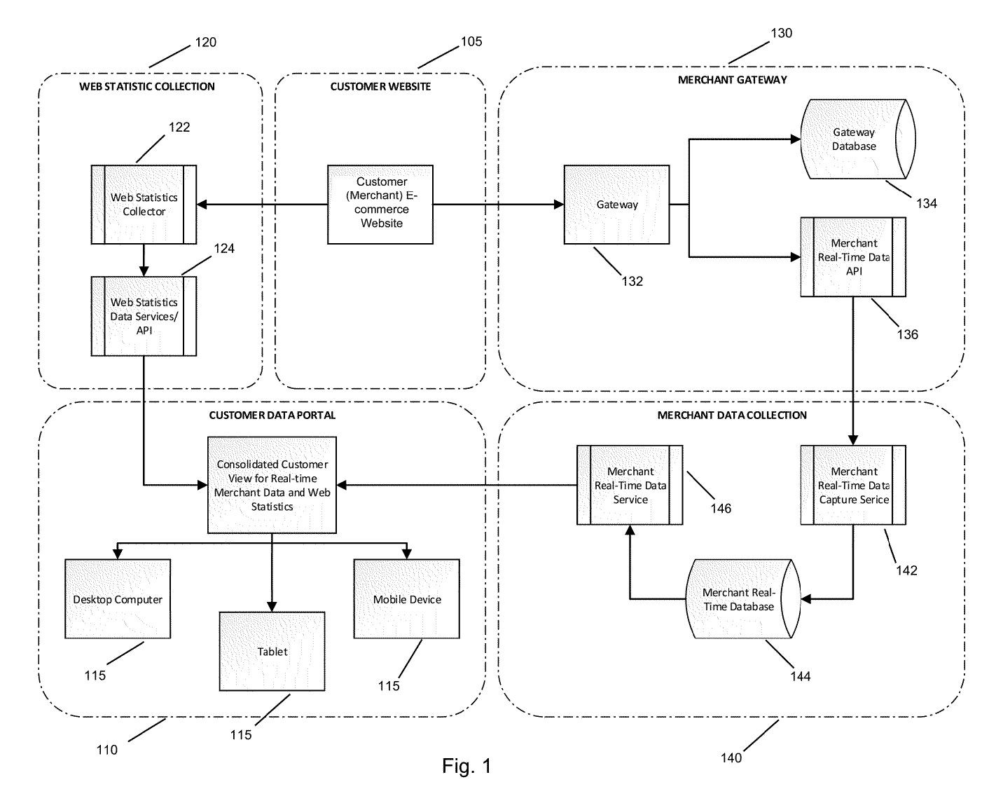

FIG. 1 is a block diagram showing the components of a real-time data capture and distribution system for e-commerce payment transactions and website activity statistics. One of ordinary skill in the art would recognize that the blocks of this diagram are a functional representation of a combination of computer hardware and software. The blocks are connected via public computer networks, e.g., the Internet, or internal networks, such as intranets and/or local area networks.

The system includes a customer e-commerce website 105, which is a website used by a merchant to sell goods online. The merchant may be a customer of an e-commerce web service provider which hosts the merchant's website and provides various forms of computer-related support for the e-commerce activities of the merchant.

As discussed in further detail below, real-time data relating to e-commerce payment transactions and website activity statistics associated with the merchant's website 105 are aggregated and presented to the merchant via a customer data portal subsystem 110. The portal 110 hosts an application which provides consolidated customer/merchant view of these two important data streams in real-time via one or more computing devices 115 of the customer/merchant, including, for example, mobile devices, such as tablet devices and mobile phones.

The data relating to e-commerce payment transactions and website activity statistics are aggregated through two separate subsystems, as discussed below.

To aggregate the website activity statistics data, various data relating to website activity at the merchant's e-commerce website are output to a web statistics collection subsystem 120. The subsystem includes a web statistics collector (WSC) 122, which is computer-implemented software responsible for collecting and aggregating the e-commerce web site statistics. The WSC reads web server logs from the server on which the merchant's website resides and stores this information in a database, e.g., as a flat file.

The data aggregated by the WSC is accessible via web statistics data service (WSDS) application programming interface (API) 124. This API allows data communication between the WSC 122 and various external applications using XML and SOAP. For example, the customer data portal application makes web services calls using XML and SOAP to the WSDS API 124, which returns the data stored in the flat files by the WSC 122. This returned data is then displayed via the user interface of a customer computing device 115, e.g., a desktop computer; tablet computer, or other mobile device, by the customer data portal. In certain embodiments, the customer data portal 110 does not store any of the presented data.

To aggregate the e-commerce payment transactions data, various data are extracted from the electronic payment processing system gateway 130 via a merchant data collection subsystem 140. The merchant data collection subsystem 140 includes a merchant real-time data capture service (MRTDCS) 142 which extracts electronic payment data from the merchant gateway subsystem. This extracted data is stored in a merchant real-time database 144 so that both current and historical/cumulative payment data can be presented to the customer/merchant. The stored data is output from the database 144 by a merchant real-time data service (MRTDS) 146, e.g., by a data push operation. Alternatively, an API may be provided to allow access to the stored data by the customer data portal application.

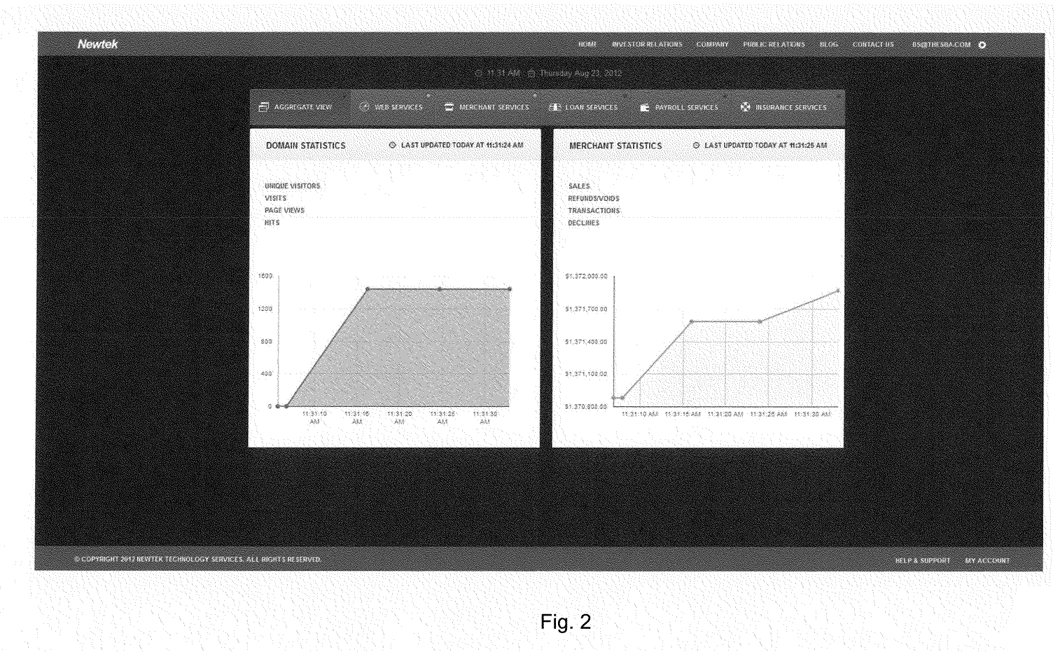

FIG. 2 depicts an example of a data screen presented on an electronic device of a user showing charts of e-commerce payment transactions and website activity statistics. The data displayed on the screen includes both e-commerce payment transaction data aggregated via the merchant data collection subsystem and website activity statistics data aggregated via the web statistics collection subsystem. Various types of information may be displayed by selecting tabs presented on the screen.

Under the tab “aggregate view,” the web activity statistics data may be presented on one side of the screen as a graph of unique visitors, visits, page views, and/or hits versus time. These various parameters may be selected using buttons presented on the screen. At the same time, merchant statistics, e.g., payment/transaction data, may be presented on the other side of the screen as a graph of sales, refunds/voids, transactions, and/or declines versus time. These various parameters may be selected using buttons presented on the screen. Of course, it is possible to overlay both merchant statistics and web activity statistics on a single graph versus time. The scales of the axes, as well as other graphical parameters, may be adjusted by the user as desired.

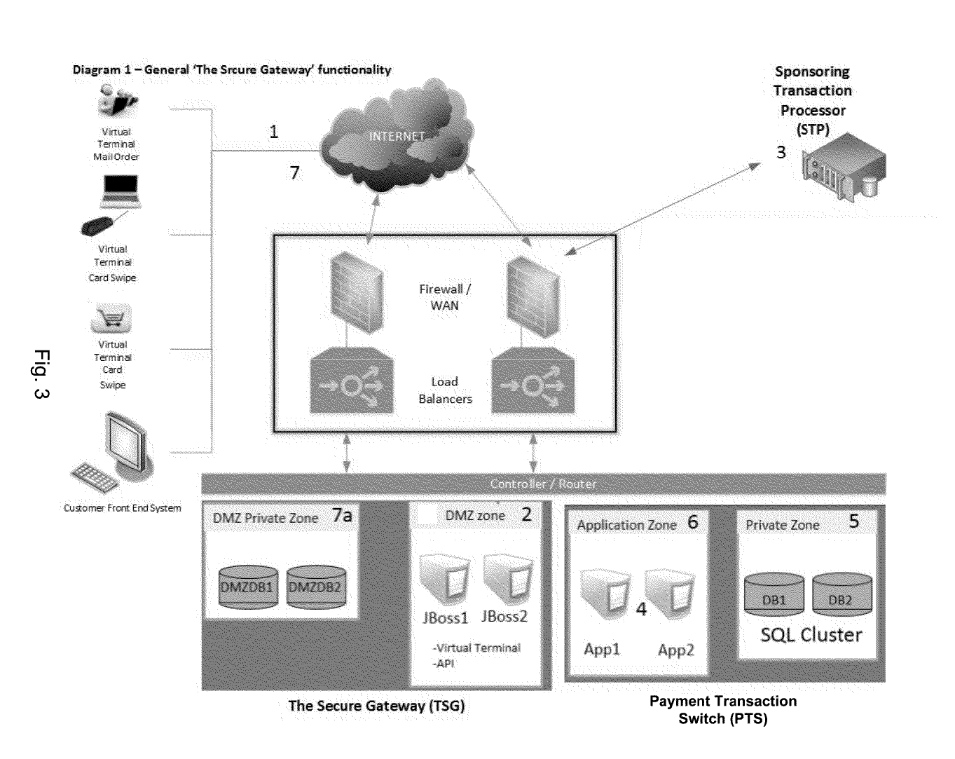

Referring again to FIG. 1, as discussed above, the merchant real-time data capture service (MRTDCS) 142 extracts electronic payment data from the merchant gateway subsystem 130. In this embodiment, the merchant gateway subsystem 130 includes three main components: a gateway server 132 (identified as “gateway” in FIG. 1), a gateway database 134, and a merchant real-time data API 136. There may also be a payment transaction switch (see FIG. 3) which is associated with the gateway server 132 and which is used to establish a connection to a credit card processor, such as First Data Corporation.

As noted above, conventional gateways such as, for example USA ePay and Authorize.Net, do not provide real-time external access to transaction data. By contrast, the disclosed embodiments provide an API, i.e., the MRTD API 136, which allows access to payment transaction data in real-time based on a merchant identification number (“merchant ID”). Moreover, for security purposes, the gateway of the disclosed embodiments is designed in such a way that it does not store credit card data.

Thus, the merchant gateway 130 subsystem of FIG. 1 allows the flow of real-time information out of the gateway 132 into a separate database, i.e., the gateway database 134, which is accessed by the MRTD API 136. This data, which is retrieved based on a merchant ID, passes to the MRTDCS 142, as noted above. The data, in turn, passes through the merchant data collection subsystem 140 to the customer data portal 110, as discussed above, to produce information in graphical form for the customer/merchant.

FIG. 3 is a more detailed block diagram of the merchant gateway subsystem (i.e., “secure gateway”). A merchant may use a virtual terminal (1), e.g., an API, or a “shopping cart,” to initiate a transaction, e.g., a credit card payment. The term “virtual terminal” refers to software and/or firmware which resides on a device or computer and allows for a secure connection to the gateway via a public network, such as the Internet, and which generates and transmits data to the gateway to effect a payment transaction. In the example of FIG. 3, the virtual terminal sends a transaction request to the gateway (e.g., TSG) and a payment transaction switch (PTS) (2). The transaction data passes through firewalls which protect the gateway and a set of load balancers which help distribute the incoming data in an efficient manner. The incoming transaction data is processed by a set of applications (e.g., App1 and App2) which perform certain data manipulations and storage operations.

For transactions which require external authorization, e.g., a credit card payment, an outgoing message is created and sent out through the firewalls to a sponsoring transaction processor (STP) (3). Upon receiving a response from the SIP, the sensitive data is wiped from the returning information or protected, and all pertinent information is placed in application logs (4). In particular, the transactions are written to the PTS transaction log databases, including truncated personal account numbers (PAN) (or, more generally, account identifiers) (5). A response is formatted and sent to the TSG gateway (e.g., in ISOXML form) (6). A response is formatted (e.g., in ISOXML form) and sent to the merchant's virtual terminal (7). The transaction is also written to the gateway transaction log and may be configured to include only the last four digits of the personal account number (PAN) (7a).

In certain embodiments, the secure gateway (TGS) also provides other capabilities which can be used to provide additional features to customers. For example, the secure gateway has the ability to manage recurring billing for a common service to a customer. This is useful in instances in which a business may not have software capable of executing a time-sensitive recurring charge to an account. In such a case, the customer can enter then account into TSG and allow the gateway to execute a scheduled recurring charge.

In certain embodiments, TSG may have the ability to take native calls from an e-commerce element, such as a shopping cart or other software process, which was originally using a conventional gateway, e.g., USAePay or Authorize.net. Specifically, TSG may emulate various conventional gateways so that the sending element would not have to recode or change the calls sent to such gateways. The sending element would merely repoint the transaction information to TSG and commonly-known functionality would work as it would with a conventional gateway.

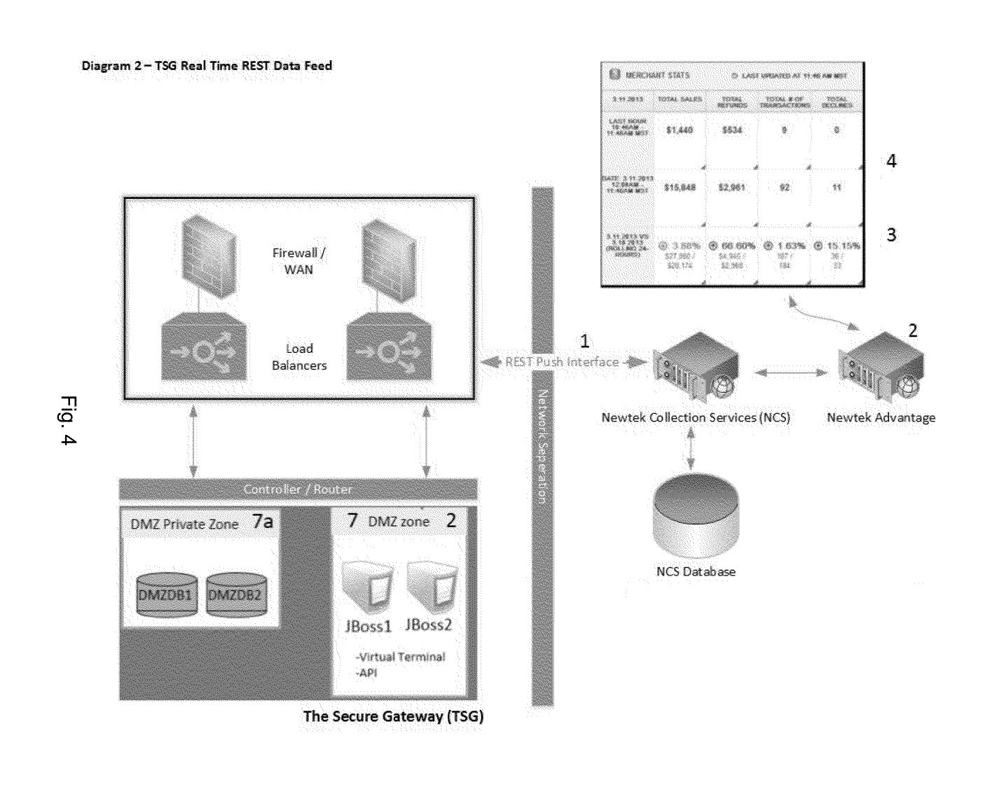

FIG. 4 is a block diagram of the merchant data collection subsystem and its interaction with the secure gateway. In this example, a transaction immediately gets “pushed” to merchant data collection subsystem, which is referred to as the Newtek Collection Services (NCS), from the gateway (TSG) via a representational state transfer (REST) interface (1), which is an application programming interface (API) for use with hypertext transfer protocol (http) in networks such as the Internet. The NCS holds the transaction information in the NCS database (2). A merchant logs on to the customer data portal, which is referred to as “Newtek Advantage” in this example, and retrieves specific transaction information (3). Newtek Advantage shows views and graphs of the merchant's transactions (4) in various formats, as discussed in further detail below.

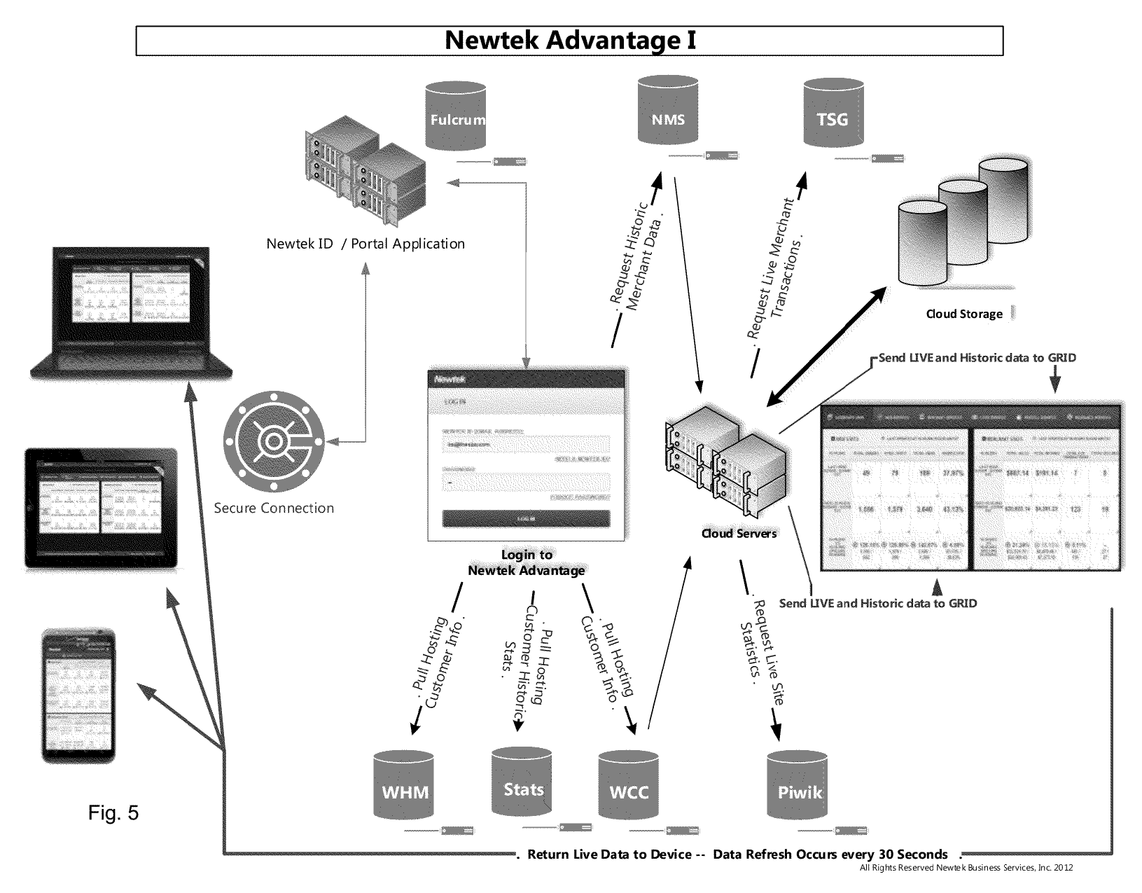

FIG. 5 is an alternative block diagram of the real-time data capture and distribution system. This diagram shows the flows of information among the databases of the system, including the secure gateway (TSG) database, which supplies real-time transaction data, and the Newtek Merchaht System (NMS) database, which stores historical transaction data so that it can be used for historical comparisons, such as, for example, daily sales versus daily sales for the same day last year. The databases may be stored separately in various locations or, as shown in FIG. 5, may be stored together in a large-scale data storage facility (e.g., using “cloud servers” and “cloud storage”).

The system of FIG. 5 may also include a sign-in portal and manager for the customer data portal. The sign-in manager, which is referred to in this example as “Newtek ID/Portal Application” may allow a customer to sign in to the customer data portal using the same credentials used for other systems provided by the provider of the customer data portal. The passwords and other sign-in credentials may be stored and managed using a database referred to as “Fulcrum” in this example.

Several databases may be used for storing web site statistics and customer information. For example, an open-source software program and database, referred to as “Piwik” may be used to accumulate and store website “click” data, i.e., data representing website visit activity, such as page visits, unique visits, and website “bounces”. A number of other databases, which are referred to in this example as web host manager (WHM), statistics (stats), and web control center (WCC) may be used to store hosting customer information and historical website statistics. This information may be used, for example, to display various types of customer-specific information on the pages presented to the customer using the customer data portal.

Generally speaking, every merchant that has been approved to take credit cards has a merchant ID. When customer makes a purchase from a particular e-commerce website, the payments network identifies that transaction by merchant ID. That merchant ID number is transferred through the gateway to the payment processing networks. The system retrieves the transaction data from the gateway, strips off the merchant ID in real-time and stores the data in the merchant real-time database via the MRTDCS.

In certain embodiments, data from both the MRTDCS and the web statistics collector (WSC) may be combined and stored in the merchant real-time database. The information in the merchant real-time database may be pushed, e.g., every second, into the customer data portal via the merchant real-time data service.

To access the information this combined information via the customer data portal, the merchant can access a particular website using their computing device and enter a user ID and password. Alternatively, the user can download and launch an application (i.e., an app) on their device.

As described above, the disclosed embodiments present two important data streams to the merchant: payment transactions and web activity. For example, the merchant can watch sales in dollars in real-time and when switch immediately to other types of transaction information, such as, for example, credit card chargebacks. This sort of transaction information, conventionally, is only available after a 24-hour period. In the disclosed embodiments, by contrast, this information can be pushed in real-time to the merchant's iPad or other device. This data can be viewed in numerous different formats. For example, the information can be tracked instantaneously or by the minute or hour.

With the disclosed system, a merchant, for example, can view real-time data from their website during an advertising campaign, which may involve advertisements appearing at a certain time each day. For example, if the advertising campaign is on a local radio station in the 8:00 to 10:00 AM drive time, and there is very little sales activity, then the merchant could call the radio station and change a promotional discount from 20% 40%. This allows a merchant to react in real-time to sales and web traffic activity.

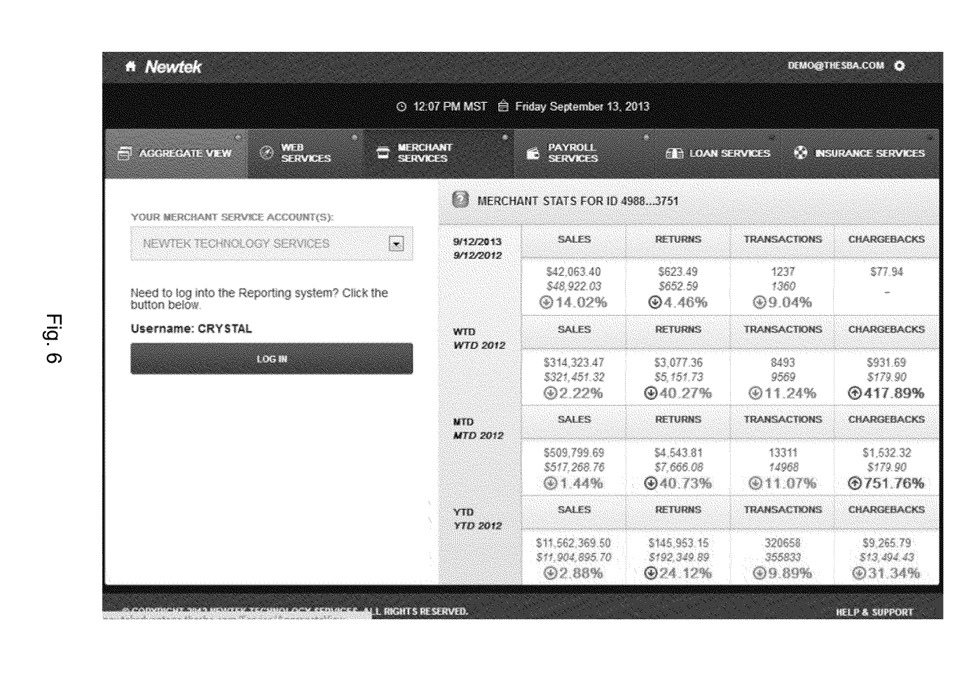

FIG. 6 depicts an example of a data screen presented on an electronic device of a user showing cumulative merchant payment transaction statistics for specific periods of time. The screen may be presented, for example, on a tablet computer and may offer a user interface which includes a number of selection buttons which the user can activate by contact on a touch screen of the tablet. These buttons may allow selection of various views of merchant transaction and website activity statistics. In the example of FIG. 6, merchant transaction statistics are displayed in the form of a table which includes the amount of sales (in dollars), the amount of returns, the number of transactions and the amount of chargebacks. These numbers may be computed as cumulative values for particular time periods, such as the current day, the week-to-date, the month-to-date, and the year-to-date.

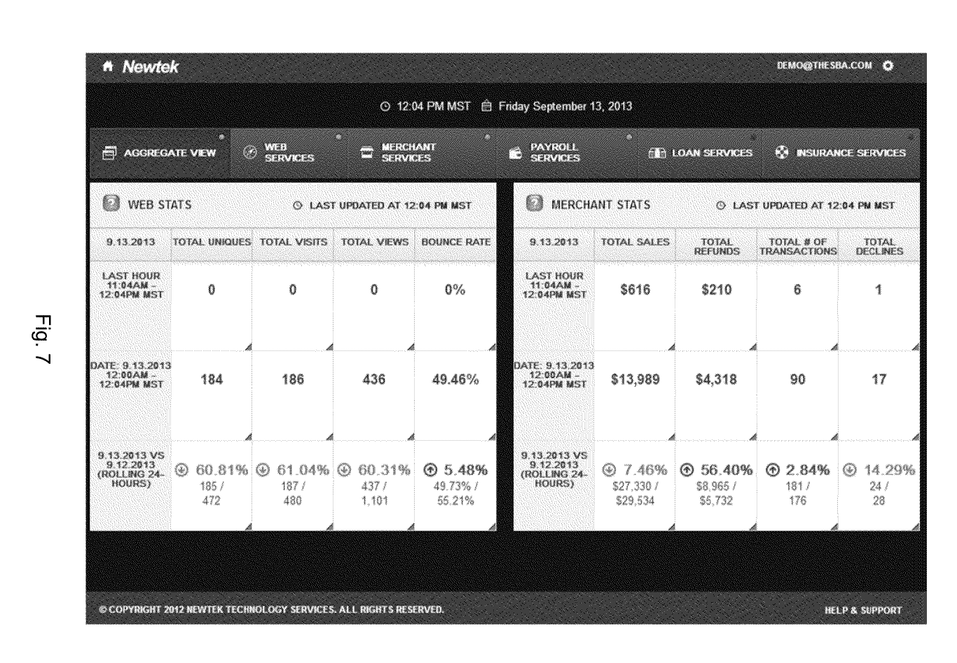

FIG. 7 depicts an example of a data screen presented on an electronic device of a user showing an aggregated view of merchant e-commerce website statistics and payment transaction statistics. This particular view may be selected by activating the “Aggregate View” button on the menu bar of the main user interface screen. The resulting screen may show, e.g., in tabular form, both e-commerce payment transaction data aggregated via the merchant data collection subsystem and website activity statistics data aggregated via the web statistics collection subsystem, as with FIG. 2, discussed above.

The web statistics displayed in the aggregate view may include the total number of unique website visits during a specific period, e.g., the last hour, the last 24 hours, etc., or a comparison of a specific time period to a corresponding historical period, e.g., the total number of unique visits for a particular day versus the same day last year. Such comparisons may be displayed in terms of percentage increase or decrease of the current period versus the historical period. The web statistics may also include the total number of website visits, the total number of views, and the “bounce rate,” which represents the percentage of visitors who enter the website and “bounce” (i.e., leave the site) after viewing a single page, rather than continuing to view other pages within the same site. The web statistics may also include the total number of views, which represents the total number of pages of the website viewed by a visitor (including repeated viewing of a page).

The merchant payment transaction statistics displayed in the aggregate view may include total sales (in dollars), total refunds, total number of transactions, and total number of declined payments. As with the website statistics, the transaction statistics may be defined during a specific period, e.g., the last hour, the last 24 hours, etc., or as a comparison of a specific time period to a corresponding historical period, e.g., the total sales for a particular day versus the same day last year. Such comparisons may be displayed in terms of percentage increase or decrease of the current period versus the historical period.

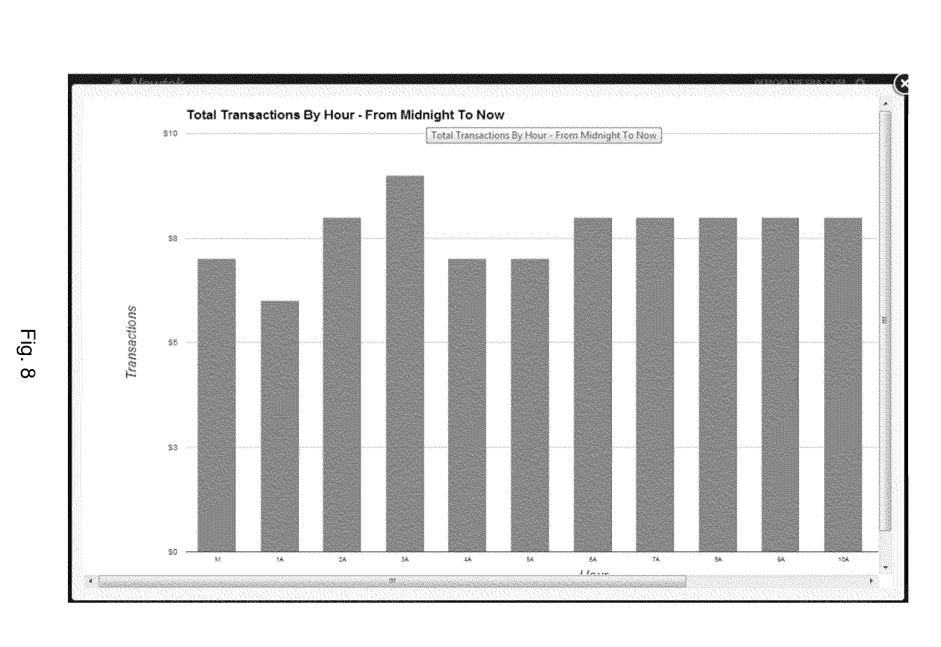

FIG. 8 depicts an example of a data screen presented on an electronic device of a user showing a rate merchant payment transactions over a specific period of time. In this particular example, the transaction data is presented as a bar graph, with each bar representing the total number of transactions in a particular time period, e.g., one hour. The bar graph spans a particular period, e.g., from midnight to the current hour. Various other types of graphical and/or textual formats may be used to display the data set, such as, for example, line graphs, tables, pie charts, histograms, etc.

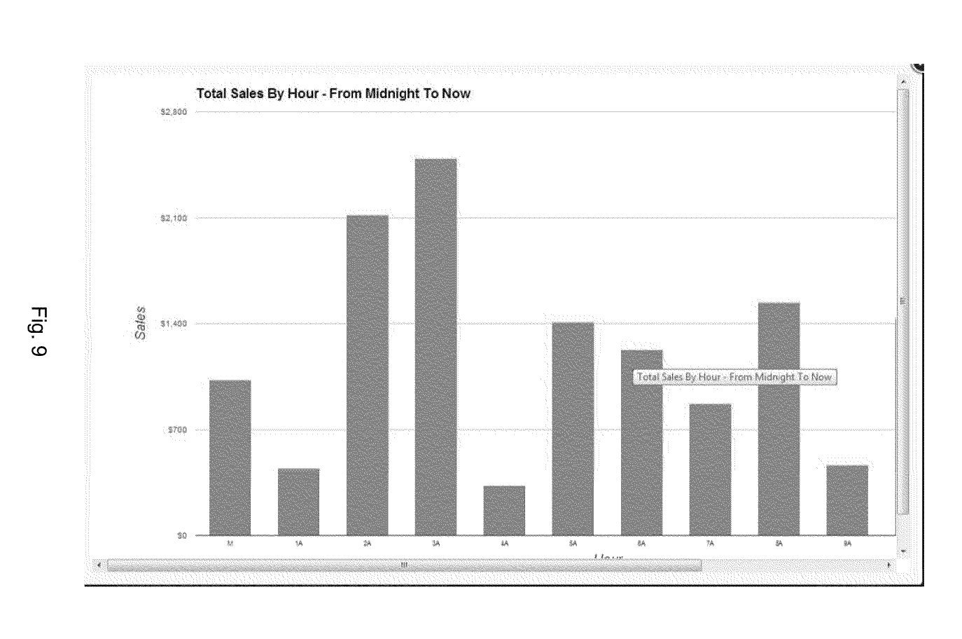

FIG. 9 depicts an example of a data screen presented on an electronic device of a user showing total merchant sales over a specific period of time. The format of this particular example is similar to FIG. 8, discussed above, except that the bars of the chart each depict the total amount of sales (in dollars) for the particular time period, e.g., one hour.

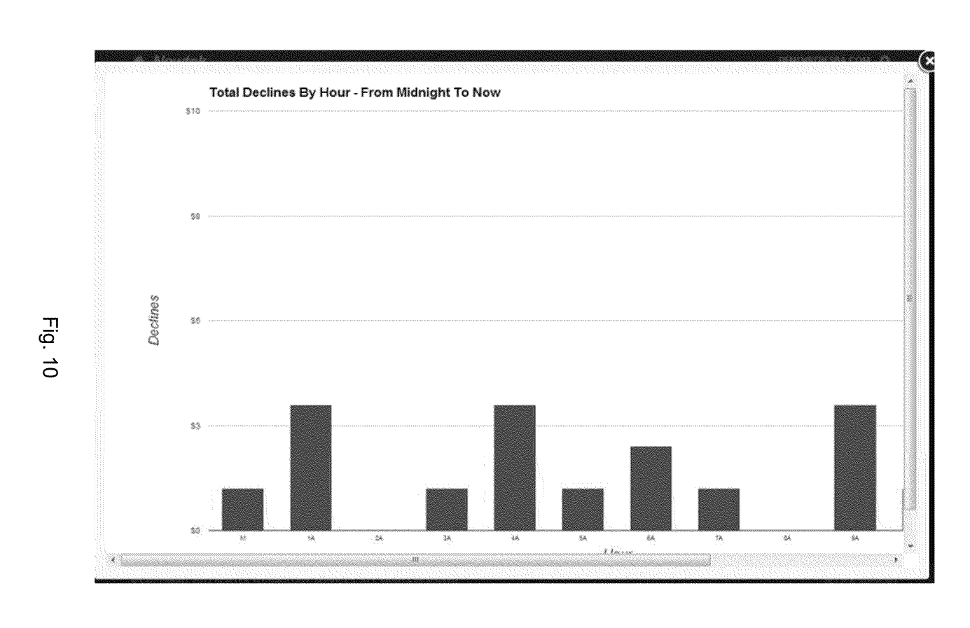

FIG. 10 depicts an example of a data screen presented on an electronic device of a user showing payment transactions declined over a specific period of time. The format of this particular example is similar to FIG. 8, discussed above, except that the bars of the chart each depict the total number of declined payment transactions in the particular time period, e.g., one hour.

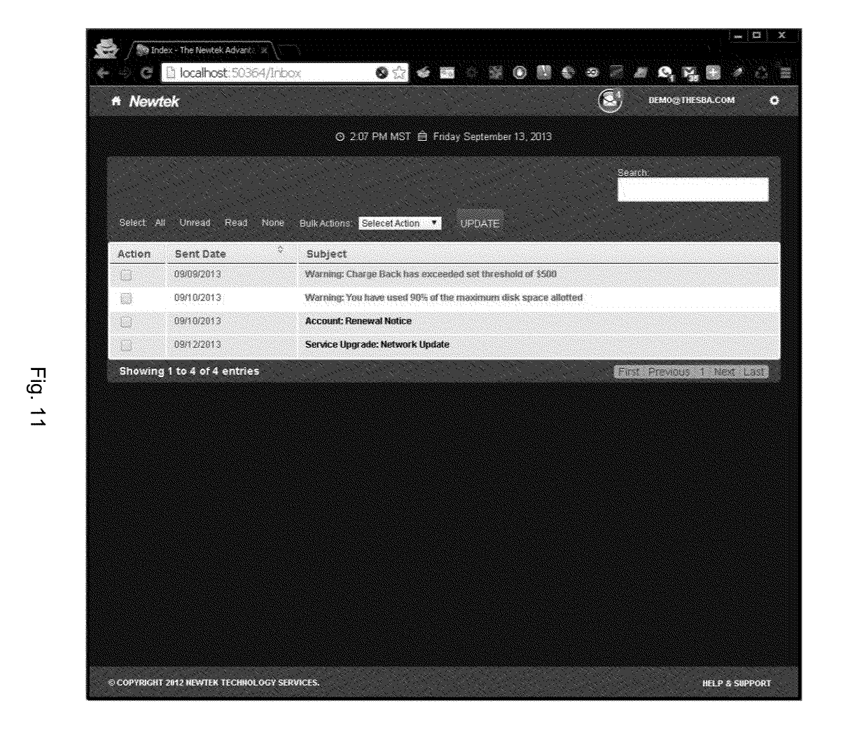

FIG. 11 depicts an example of a data screen presented on an electronic device of a user showing an inbox of received messages relating to merchant payment transactions and administrative information. This screen may provide various types of information to the merchant in the form of messages which are akin to emails. A list of messages may be displayed in order of receipt with a column indicating the receipt date, or receipt date and time, the subject of the message, and optionally the name of the sender of the message.

The messages may concern administrative matters, such as, for example, an amount of disk space being used by the merchant for stored transaction data. The messages may also include warnings and/or alerts tied to particular website and/or transactional parameters. For example, the system may be configured to provide an alert message when a chargeback is made in a dollar amount which exceeds a defined threshold. Various other types of alert messages may be sent by the system, such as, for example, sales transaction volume limits (i.e., low and/or high limits), declined transaction limits, refund limits, etc. The particular parameters of each alert may be based on a system-wide set of defined alerts and/or alerts which are individually defined by each merchant.

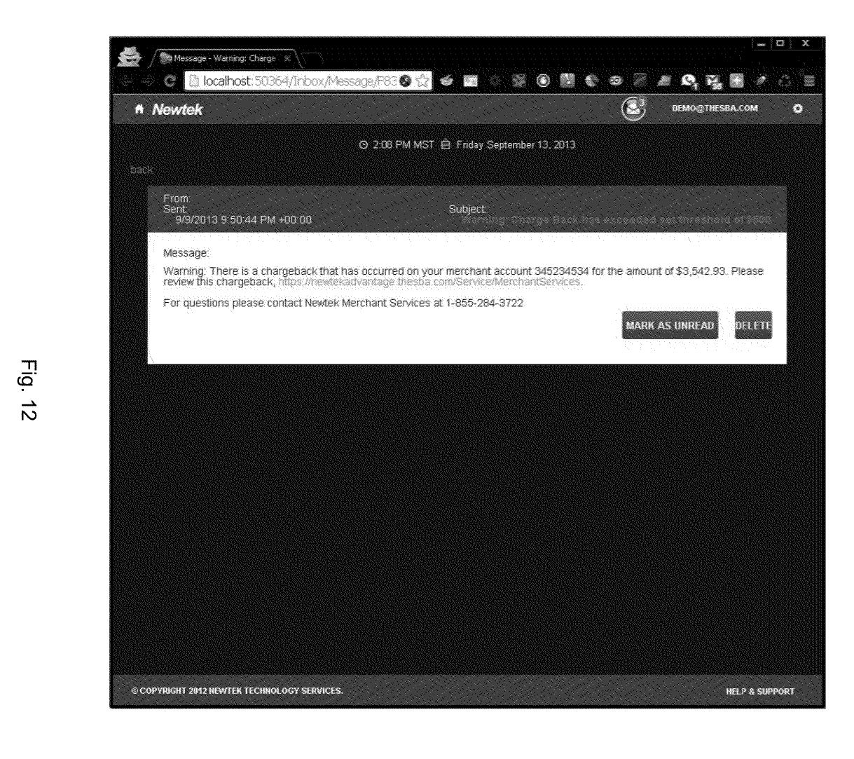

FIG. 12 depicts an example of a data screen presented on an electronic device of a user showing a received message relating to merchant payment transaction chargebacks. The message, in this particular example, relates to a chargeback in a dollar amount which exceeds a defined threshold. The user, i.e., the merchant, may be directed to review the chargeback to ensure that it is not fraudulent. For example, the message may provide a link which the merchant can activate to view data relating to the chargeback transaction in question. As in a typical email system, the message screen may provide various options for marking a messages as unread or deleting the message.

Although example embodiments have been shown and described in this specification and figures, it would be appreciated by those skilled in the art that changes may be made to the illustrated and/or described example embodiments without departing from their principles and spirit.

What is claimed is:

1. A method for performing real-time data capture and distribution for e-commerce payment transactions, the method comprising:
receiving, at a secure gateway comprising data storage and a network interface, a payment transaction request sent from a virtual terminal of a customer website via a network, the payment transaction request comprising a merchant identifier associated with the virtual terminal;
storing payment transaction data in a database accessible by the secure gateway, the payment transaction data being based on the transaction request;
sending the payment transaction data from the secure gateway, via the network, to be stored by a merchant data capture service in association with the merchant identifier, the merchant data capture service comprising data storage and a network interface;
retrieving, by a customer data portal at least partially executing on a processor of a customer device, the payment transaction data from the merchant data capture service based on the merchant identifier; and
presentation on the customer device, by the customer data portal, of the payment transaction data.

2. The method of claim 1, further comprising:
storing, by the merchant data capture service, website activity statistics from the customer website in association with the merchant identifier;
retrieving, by the customer data portal, website activity statistics for the customer website from a web statistics collector based on the merchant identifier; and
presentation on the customer device, by the customer data portal, of the website activity statistics.

3. The method of claim 2, wherein the customer data portal simultaneously presents portions of the payment transaction data and corresponding portions of the website activity statistics on the customer device.

4. The method of claim 1, further comprising:
sending payment information based on the transaction request via the network to a payment processor for authorization; and
receiving, at the secure gateway, a payment authorization response from the payment processor via the network in response to the payment information.

5. The method of claim 4, wherein the steps of sending payment information to the payment processor and receiving the payment authorization response are performed by a payment transaction switch associated with the secure gateway.

6. The method of claim 1, wherein the payment transaction data is sent from the secure gateway to be stored by the merchant data capture service through a data push operation.

7. The method of claim 1, wherein the retrieving of the payment transaction data by the customer data portal includes retrieval of historical payment transaction data stored by the merchant data capture service.

8. The method of claim 1, wherein the payment transaction request comprising a personal account identifier, and the method further comprises:
processing the personal account identifier to form a protected account identifier; and
storing the protected account identifier as part of the payment transaction data.

9. A system for performing real-time data capture and distribution for e-commerce payment transactions, the system comprising:
a secure gateway comprising data storage and a network interface, the secure gateway being configured to receive a payment transaction request sent from a virtual terminal of a customer website via a network, the payment transaction request comprising a merchant identifier associated with the virtual terminal;
a database which is accessible by the secure gateway and which is configured to store payment transaction data based on the transaction request received by the secure gateway;
a merchant data capture service subsystem comprising data storage and a network interface and being configured to receive the payment transaction data sent from the secure gateway, via the network, and store the payment transaction data in association with the merchant identifier; and
a customer data portal at least partially executing on a processor of a customer device and being configured to retrieve the payment transaction data from the merchant data capture service based on the merchant identifier and further being configured to present the payment transaction data on the customer device.

10. The system of claim 9, further comprising a web statistics collector which is configured to provide website activity statistics for the customer website, wherein the merchant data capture service subsystem is further configured to store the website activity statistics from the customer website in association with the merchant identifier; and
wherein the customer data portal is further configured to retrieve the website activity statistics for the customer website from the web statistics collector based on the merchant identifier and present the website activity statistics on the customer device.

11. The system of claim 10, wherein the customer data portal is configured to simultaneously present portions of the payment transaction data and corresponding portions of the website activity statistics on the customer device.

12. The system of claim 9, wherein the secure gateway is further configured to send payment information based on the transaction request via the network to a payment processor for authorization and receive a payment authorization response from the payment processor via the network in response to the payment information.

13. The system of claim 9, further comprising a payment transaction switch associated with the secure gateway, the payment transaction switch being configure to send payment information based on the transaction request via the network to a payment processor for authorization and receive a payment authorization response from the payment processor via the network in response to the payment information.

14. A computer-readable medium storing a computer program which, when executed on a processor, performs a method for real-time data capture and distribution for e-commerce payment transactions, the method comprising:
receiving, at a secure gateway comprising data storage and a network interface, a payment transaction request sent from a virtual terminal of a customer website via a network, the payment transaction request comprising a merchant identifier associated with the virtual terminal;
storing payment transaction data in a database accessible by the secure gateway, the payment transaction data being based on the transaction request;
sending the payment transaction data from the secure gateway, via the network, to be stored by a merchant data capture service in association with the merchant identifier, the merchant data capture service comprising data storage and a network interface;
retrieving, by a customer data portal at least partially executing on a processor of a customer device, the payment transaction data from the merchant data capture service based on the merchant identifier; and
presentation on the customer device, by the customer data portal, of the payment transaction data.
